(19) United States
(12) Patent Application Publication
(10) Pub. No.: US 2006/0130208 A1
(43) Pub. Date: Jun. 22, 2006

(54) Impact device and method

(75) Inventor: James C. Likens, Indianapolis, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(73) Assignee: Triadic Strategic Technologies, LLC

(21) Appl. No.: 11/258,854

(22) Filed: Oct. 26, 2005

Related U.S. Application Data
(63) Continuation of application No. 10/654,729, filed on Sep. 4, 2003, now abandoned.

(51) Int. Cl. A41D 13/06; A41D 13/00; B64D 1/04; F41C 9/02

(52) U.S. Cl. 2/22; 89/1.1; 89/36.05; 42/1.09

(57) ABSTRACT

An impact device and method for use in incapacitating an opponent. The device mounts on the lower part of the leg and is used by kicking the opponent with the impact device. A police version of the device has a rounded surface for exerting a measured blow on the opponent while a military version has a cutting edge for cutting the opponent. The device may be covered and obscured by the pant leg of the user.

### CROSS REFERENCE TO RELATED APPLICATIONS

This application is a continuation of U.S. application Ser. No. 10/654,729, filed, Sep. 4, 2003, which is incorporated herewith by reference.

### FIELD OF THE INVENTION

This invention relates to an impact device and method.

### BACKGROUND OF THE INVENTION

Police officers have official guidelines as to how much force they should use in a particular situation. For example, the amount of force to be used might be coded as green, yellow or red depending on whether there is no danger to the officer, or mortal danger, or an intermediate situation where the individual is illegally resisting arrest but there is little or no danger to the officer. A police officer frequently carries a pistol which might be grabbed by a criminal if the officer does not protect the pistol by grasping it or by covering it with his hand. It is desirable that the police officer have available a weapon permitting the officer to apply measured force and at the same time to protect the officer's pistol.

### SUMMARY OF THE INVENTION

It is therefor an object of the invention to provide an improved weapon for use by a police officer permitting the application of a measured amount of force.

Another object of the invention is to provide an impact weapon for use by the military.

One embodiment of the invention is an impact weapon including a main body having an elongated curved shape for mounting on the shin. The body has an inside curved surface adapted to nest on the shin and has an outside surface. A retainer is secured to the main body for retaining the main body on the shin. An elongated rigid member is fixed to the outside surface of the main body and extends along the length of the main body.

Another embodiment of the invention is a method for subduing an opponent which includes providing an impact weapon with a main body having an elongated curved shape for mounting on the shin. An elongated rigid member is secured to the outside surface of the main body and extends along the length of the main body. The method further includes securing the weapon to the shin and striking the opponent with the elongated rigid member by kicking the opponent with the weapon.

Still another embodiment of the invention is an impact weapon including a main body having an inside surface adapted to nest on the lower part of the leg. A retainer is arranged to secure the main body to the lower part of the leg. The main body has an outside surface to which is fixed a rigid member which has a relatively flat striking surface.

Still a further embodiment of the invention is a method for subduing an opponent which includes providing an impact weapon which has a main body with an inside surface adapted to nest on the lower part of the leg. A rigid member having a relatively flat striking surface is secured to the outside surface of the main body. The method further includes securing the weapon to the lower part of the leg and striking the opponent with the relatively flat striking surface by kicking the opponent with the weapon.

### BRIEF DESCRIPTION OF THE DRAWINGS

FIG. 1 is a view of a policeman having a pistol in a holster and also having the impact device of the present invention mounted on the policeman's right leg.

FIG. 2 is a perspective view of the impact device.

FIG. 3 is a side elevation of the device.

FIG. 4 is an end elevation of the device.

FIG. 5 is a view of the policeman of FIG. 1 carrying out a step of the present invention.

FIG. 6 is a fragmentary view similar to FIG. 4 of an alternative embodiment of the invention.

FIG. 7 is a fragmentary side elevation of an impact device forming an alternative embodiment of the invention.

FIG. 8 is a fragmentary perspective view of a further impact device forming an alternative embodiment of the invention.

FIG. 9 is a perspective view of an impact device forming an alternative embodiment of the invention.

FIG. 10 is a perspective view of an impact device forming an alternative embodiment of the invention.

FIGS. 11 and 12 are perspective view of the impact devices forming further alternative embodiments of the invention.

### DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, and alterations and modifications in the illustrated device, and further applications of the principles of the invention as illustrated therein are herein contemplated as would normally occur to one skilled in the art to which the invention relates.

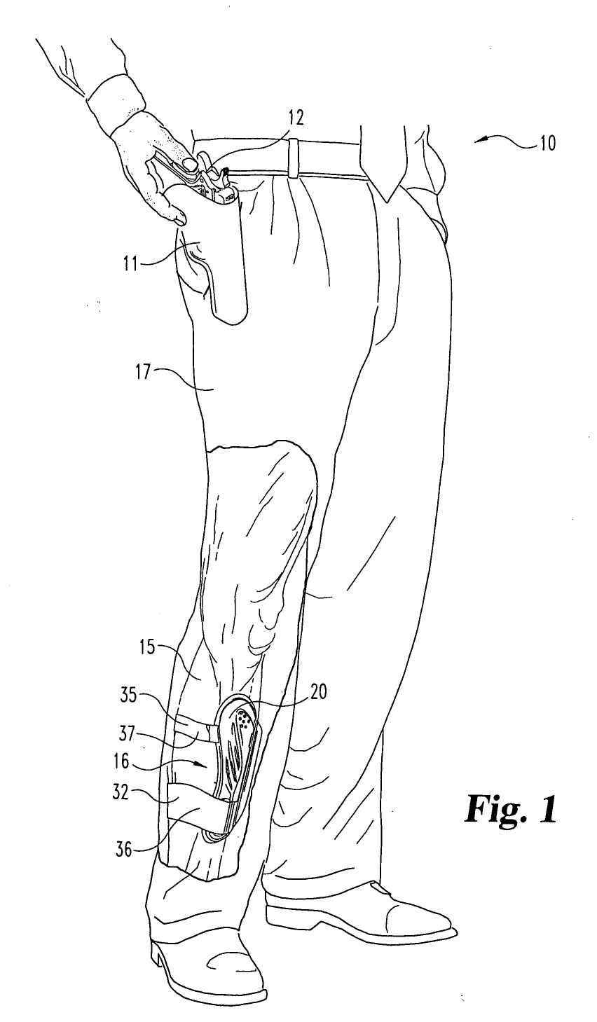

Referring to FIG. 1, a police officer 10 is illustrated having a holster 11 with a pistol 12 received within the holster 11. Mounted on the right leg 15 of the police officer is the impact device or weapon 16 of the present invention. (The police officer's right pant leg is broken away to show the mounting of the impact device.) The police officer 10 has on long pants 17 which cover the impact device 16 and make it obscured from view of a criminal. The illustrated police officer in FIG. 1 is right handed and consequently has the impact device 16 mounted on his right leg. The officer has a pistol belt carrying the holster and pistol where they are easily accessible by his right hand. A left handed police officer would have the impact device 16 mounted on his left leg and would have his holster and pistol at his left side accessible by his left hand.

Referring to the perspective view FIG. 2 of the impact device or weapon 16, the device or weapon includes a main body 20 which has an elongated curved shape for mounting on the shin. The main body 20 also has an inside curved surface 21 adapted to nest on the shin and also has an outside curved surface 22. A cushion 25 is mounted on the main body 20 on the inside curved surface 21 and covers the inside curved surface for protecting and cushioning the shin of the wearer of the impact device. An elongated rigid member 26 is fixed to the outside curved surface 22 of the main body and extends along the length of the main body.

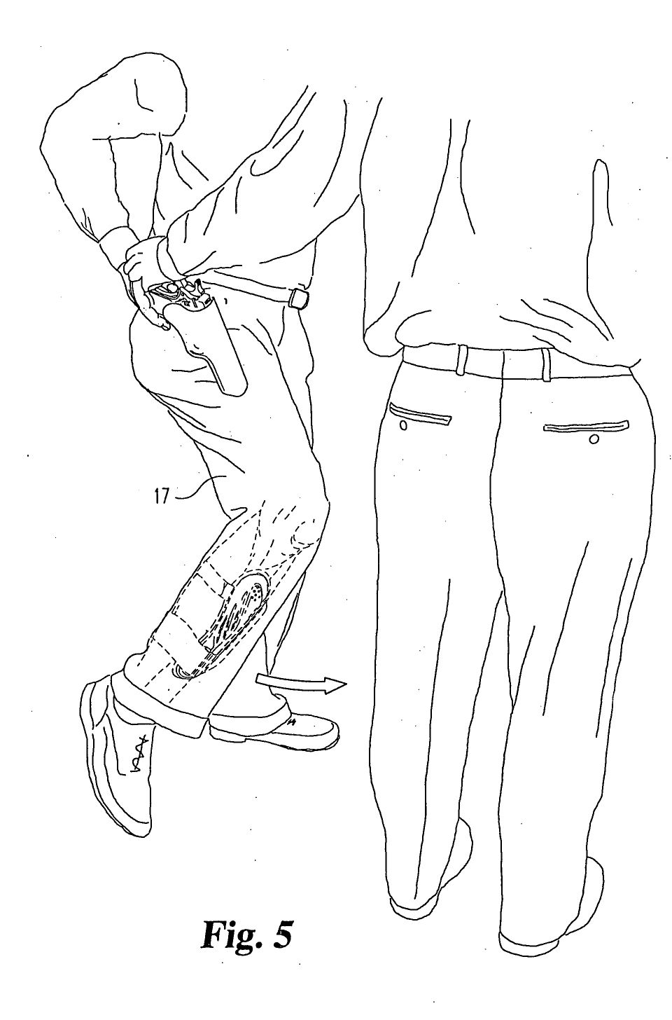

FIG. 5 shows the impact device of the present invention in use. One of the advantages of the present device is the fact that it is not visible to the perpetrator of a crime because it can be covered by the long pants 17 of the policeman. Thus the police officer can use the front of the shin of his right leg for a right handed police officer to kick a perpetrator in the leg as shown in FIG. 5 so as to bring down the perpetrator or can even use the kick on some other part of the perpetrator's body if a more crippling force is necessary for a particular situation. When the officer kicks the criminal, the cushion 25 cushions the impact to the shin of the officer. As shown by the arrow in FIG. 5, the kick can be aimed at the rear of the criminal's leg to cause the leg to buckle and the criminal to go down. At the same time that the right handed police officer is doing the kicking operation he can also use his right hand to cover his gun as shown so that it cannot be withdrawn from the holster by the perpetrator.

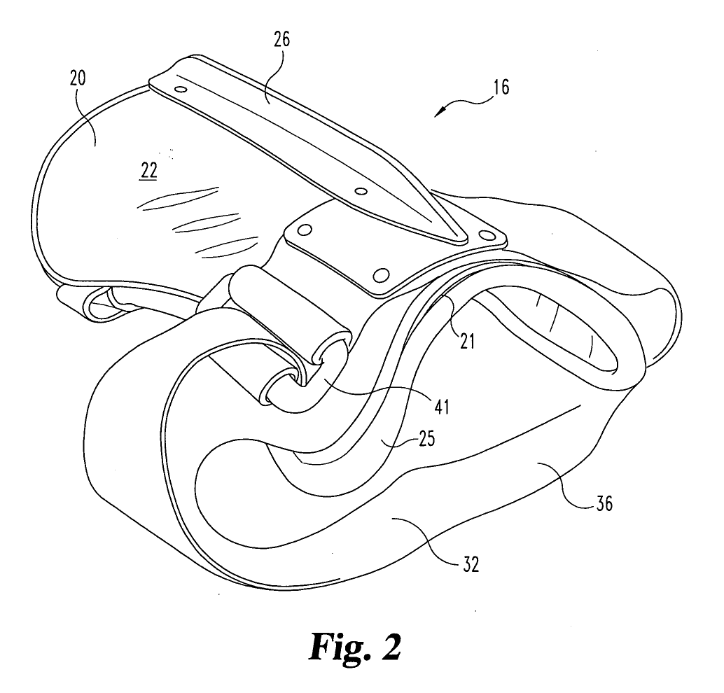

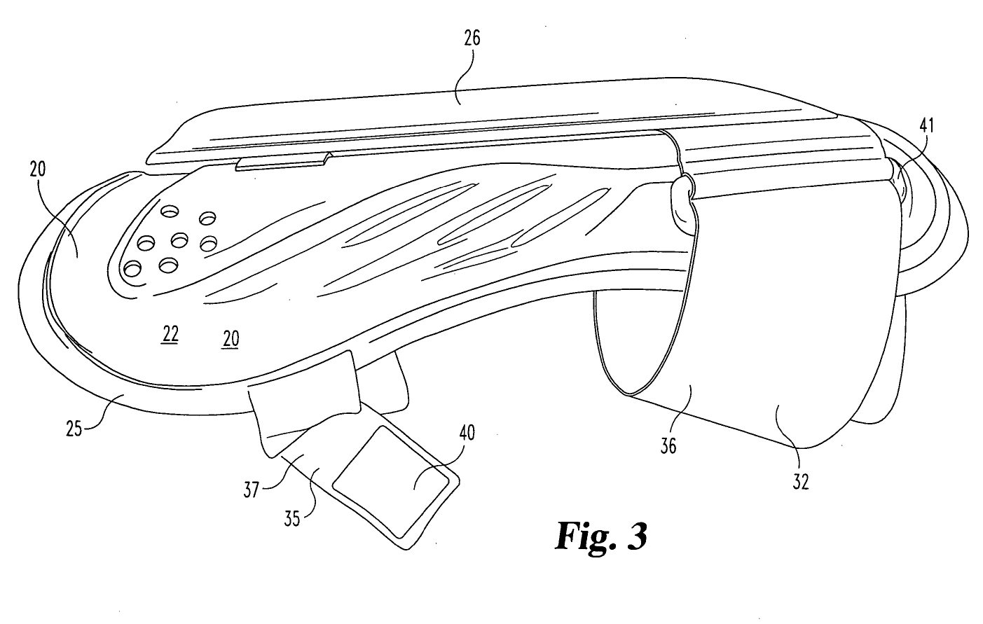

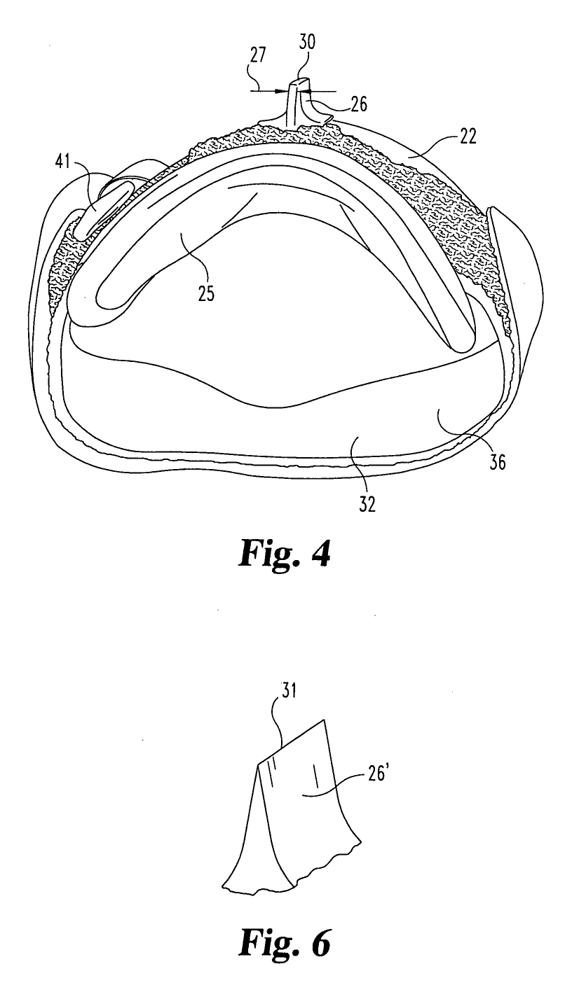

The impact device of the present invention can take various forms. The specific embodiment illustrated in FIGS. 1-5 includes a main body 20 that is approximately 9-½ inches in length. The elongated rigid member 26 has a thickness dimension 27 that is approximately ⅛ inch and has a curved surface 30 facing away from the main body. The elongated rigid member 26 is designed in this fashion in order to stun the recipient of a kick by the policeman but not to cause excessive damage by the kick. An alternative embodiment of the invention shown in FIG. 6 involves a sharp edge 31 of the elongated rigid member 26′ so that the kick would produce a cutting action. This particular alternative embodiment is intended for military use as opposed to police use. FIG. 6 is a fragmentary cross sectional view of the elongated rigid member 26′. The embodiment of FIG. 6 in other respects is identical to the embodiment of FIGS. 1-5.

The impact device 16 is secured in place on the leg of the user by a retainer and/or retainers 32 and 35. In the illustrated embodiment the retainers 32 and 35 are straps 36 and 37 which have Velcro 40 mounted on them. The strap 36 is received between the main body 20 and the elongated rigid member 26 and is secured in place by appropriate fasteners. The strap 36 has a loop or ring 41 on the strap through which the strap is inserted prior to use of the Velcro to attach the strap 36 to itself. The retainer 35 includes the strap 37 which is secured by appropriate fasteners between the main body 20 and the cushion 25. The end portions of the strap 37 have the complementary Velcro sections on them for securing the end portions together and mounting the impact device on the leg.

The invention includes other alternative embodiments. For example the elongated rigid member 26 might be constructed integrally with the main body 20. In the illustrated embodiment of the invention the elongated rigid member 26 and the main body 20 are made out of rigid plastic but they could be made out of other materials such as metal or wood as examples. One manner of constructing the impact weapon of the present invention includes modifying a commercially available soccer leg guard by adding to it and mounting on it the elongated rigid member 26. Still another alternative embodiment of the invention includes making the elongated rigid member out of more than one piece such as, for example, a series of spaced or contiguous or adjacent pieces.

Still other alternative embodiments of the invention are shown in FIGS. 7 through 11. FIG. 7 is a fragmentary side elevation and FIG. 8 is a fragmentary perspective view of impact devices 45 and 45′. Also shown in FIGS. 7 and 8 is the lower part 46 and 46′ of the leg of persons having the impact devices 45 and 45′ mounted thereon. FIGS. 7 and 8 show boots 47 and 47′ on the persons' foot. The impact device 45′ may not be elongated but does have a relatively flat striking surface 56′ on the rigid member 55′ mounted on main body 52′.

The impact device 45 can take various forms. As shown in FIG. 8 it can include a main body 52 which may be made out of (at least in part) cushioning material to protect the person's leg. Mounted on the main body 52 is a rigid member 55 which, in the illustrated example, has a length of approximately two inches although this dimension can vary. The rigid member 55 has a relatively flat striking surface 56. Both the embodiment of FIG. 7 and the embodiment of FIG. 8 are secured to the lower part of the leg by show laces 51 and 51′ which extend through eyelets in the main body 52 and 52′ and also through the eyelets of the boots 47 and 47′. Thus, in both the embodiment of FIG. 7 and the embodiment of FIG. 8 the impact device is secured to the boot as well as to the lower part of the leg of the person wearing the boot.

FIGS. 9 and 10 show two forms that the impact device can take. In FIG. 9 the impact device 59 is shown with velcro sections 60 and 61 on the strap 62 which is inserted through the slot in the main body 66 in order to secure the impact device to the lower portion of the leg. The main body 66 also has eyelets 67 through which the shoelaces of the boot are laced to secure the impact device in place. The elongated rigid member 68 is secured to the main body 66 and has a relatively flat striking surface 69. FIG. 10 shows an alternative embodiment of the invention in which the complementary velcro sections 60′ and 61′ are on opposite ends of the strap 62′ and the rigid member 68′ is secured to the strap centrally of the strap. The device of FIG. 10 can be secured to the lower part of the leg of the person by the velcro 60′ and 61′ and by lacing the boot (on the person) over the strap 62′ and the rigid member 68′.

Referring to FIG. 11, still another embodiment of the invention is illustrated as including an impact device 71 mounted on a low cut shoe 72. The impact device 71 is used in the same manner and described above by securing the shoe 72 and impact device 71 to the lower portion of the leg of the person using the impact device. The impact device 71 includes an elongated rigid member 75 and a main body 76 with the elongated rigid member 75 fixed to the main body 76. The shoelaces 80 of the shoe 72 are laced through eyelets 77 in the main body 76 to secure the impact device to the shoe and to the lower portion of the leg of the person using the impact device.

Referring to FIG. 12, still another embodiment of the invention includes an impact device 84 including a main body 85 and elongated rigid member 86 fixed to the main body 85. The elongated rigid member 86 has slots 87 through which shoe or boot laces can be laced to secure the impact device to a shoe or boot with a resulting mounting of the impact device 84 on the lower part of the leg of the user of the impact device.

Each of the impact devices illustrated in FIGS. 8 through 12 is used in the same fashion as described above with regard to the embodiments of FIGS. 1 through 6, that is, the impact device or weapon is secured to the lower part of the leg. The opponent is then struck with the rigid member by kicking the opponent with the weapon.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed:

1. An impact weapon comprising a rigid main body having an elongated curved shape for mounting on the shin below the knee, said main body having an inside curved surface adapted to nest on the shin and having an outside surface, a retainer secured to said main body for retaining said main body on the shin, an elongated rigid member fixed to the outside surface of the main body and extending along the length of the main body.

2. The weapon of claim 1 additionally comprising a cushion mounted on said inside surface of said main body and covering said inside curved surface of said main body for protecting the shin.

3. The weapon of claim 1 wherein said elongated rigid member has an external curved surface facing away from said main body and has a thickness adjacent said external curved surface of approximately 1/8 of an inch.

4. The weapon of claim 1 wherein the elongated member has a sharp edge facing away from said main body.

5. The weapon of claim 1 wherein the main body and the elongated member are integral.

6. A method for subduing an opponent which comprises:
providing an impact weapon for the user of the weapon and including a main body having an elongated curved shape for mounting on the shin of the user and having an elongated rigid member secured to the outside surface of the main body and extending along the length of the main body;
securing the weapon to the shin of the user; and
striking the opponent with the elongated rigid member by kicking the opponent with the weapon.

7. The method of claim 6 comprising the additional step of covering the impact weapon with a pant leg of the user to obscure the weapon prior to kicking the opponent.

8. The method of claim 6 wherein the elongated rigid member is sharp whereby the striking produces a cutting action on the opponent.

9. The method of claim 6 wherein the rigid member and the main body are integral.

10. The method of claim 6 additionally comprising:
providing a cushion mounted directly on an inside curved surface of said main body and covering said inside curved surface of said main body for protecting the shin of the user.

11. The method of claim 6 and further comprising:
providing on said elongated member an external curved surface facing away from the main body and a thickness adjacent said external curved surface of approximately ⅛ of an inch.

12. The method of claim 6 and further comprising:
providing on said elongated member a sharp edge facing away from said main body.

13. An impact weapon comprising a main body having an inside surface adapted to nest on the lower part of the leg below the knee, a retainer arranged to secure said main body to the lower part of the leg, said main body having an outside surface, and a rigid member fixed to the outside surface of the main body, said rigid member having a relatively flat striking surface.

14. The impact weapon of claim 13 additionally comprising velcro forming part or all of said retainer.

15. A method for subduing an opponent which comprises:
providing an impact weapon including a main body having an inside surface adapted to nest on the lower part of the leg below the knee and having a rigid member secured to the outside surface of the main body, said rigid member having a relatively flat striking surface;
securing the weapon to the lower part of the leg below the knee; and
striking the opponent with the relatively flat striking surface of the rigid member by kicking the opponent with the weapon.

16. The method of claim 15 and further comprising covering the impact weapon with a pant leg to obscure the weapon prior to kicking the opponent.
